(19) United States
(12) Patent Application Publication
(10) Pub. No.: US 2014/0285020 A1
(43) Pub. Date: Sep. 25, 2014

(54) PORTABLE POWER SUPPLY

(71) Applicant: ZONESKING TECHNOLOGY CO., LTD., NEW TAIPEI CITY (TW)

(72) Inventors: TZU-YU YANG, New Taipei City (TW); LI-BANG CHEN, Taichung City (TW); JIA-YI WU, New Taipei City (TW)

(73) Assignee: ZONESKING TECHNOLOGY CO., LTD., NEW TAIPEI CITY (TW)

(21) Appl. No.: 14/065,433

(22) Filed: Oct. 29, 2013

(30) Foreign Application Priority Data
Mar. 22, 2013 (TW) 102205385

(51) Int. Cl. H02J 4/00

(52) U.S. Cl. CPC H02J 4/00
USPC 307/43

(57) ABSTRACT

The portable power supply contains a circuit unit and a rechargeable battery. The circuit unit contains a conversion circuit, an AC output port, a DC input/output port, and a coupling port. The rechargeable battery is coupled to the coupling port. The DC electricity stored in the rechargeable battery is delivered to the circuit unit through the coupling port, and then to a first branch and a second branch. Following the first branch, the DC electricity is transformed a pre-determined AC voltage by the conversion circuit, and the AC voltage is delivered to an external electronic device through the AC output port. Following the second branch, the DC electricity is directly delivered to another external electronic device through the DC input/output port. Without connecting the external electronic device, the DC input/output port is capable of connecting to an external DC power source for charging the rechargeable battery.

### TECHNICAL FIELD OF THE INVENTION

The present invention is generally related to portable power supplies, and more particular to a portable power supply capable of providing both DC and AC electricity.

### DESCRIPTION OF THE PRIOR ART

Conventional portable power supplies, using similar batteries like cellular phones, last approximately 1 to 2 years, depending on the usage of the users. However, these batteries are built in and once the batteries break down, the entire appliances using the batteries have to be thrown away, causing significant impact to the environment.

Conventional portable power supplies usually provide USB interfaces for cellular phones and tablet computers requiring no more than 5V working voltage. For devices requiring more than 5V working voltage such as notebook computers, the conventional portable power supplies incapable of supplying more than 5V working voltage are not appropriate. Some high-end portable power supplies do provide higher voltage output. However, if not carefully configured, the connected appliances could be damaged, or the appliances require genuine adaptors and those 3^{rd} party adaptors are not applicable. In other words, the disadvantages of conventional portable power supplies can be summarized as follows.

Firstly, 95% of the conventional portable power supplies are equipped with in-replaceable batteries, which are not environmentally friendly and the provision of power supply is also limited.

Secondly, due to the limitation of conventional technologies, the conventional portable power supplies cannot provide safe and high-quality DC (<5V) output voltage and DC-to-AC conversion capability.

Thirdly, for notebook and tablet computers, their power interfaces are of different specifications and the conventional portable power supplies provide working voltages that are too low.

Fourthly, most of the conventional power supplies cannot provide AC power during black out.

Fifthly, conventional portable power supplies usually use heavy lead-acid batteries, which are inconvenient in transportation and replacement, let alone their high price tags.

### SUMMARY OF THE INVENTION

Therefore, a novel portable power supply is provided herein. The portable power supply contains a circuit unit and a rechargeable battery. The circuit unit contains a conversion circuit, an AC output port, a DC input/output port, and a coupling port. The rechargeable battery is coupled to the coupling port. The DC electricity stored in the rechargeable battery is delivered to the circuit unit through the coupling port, and then to a first branch and a second branch. Following the first branch, the DC electricity is transformed a pre-determined AC voltage by the conversion circuit, and the AC voltage is delivered to an external electronic device through the AC output port. Following the second branch, the DC electricity is directly delivered to another external electronic device through the DC input/output port. Without connecting the external electronic device, the DC input/output port is capable of connecting to an external DC power source for charging the rechargeable battery.

Therefore, a major objective of the present invention is to have a portable power supply capable of powering external electronic devices either requiring either AC power or DC power, so as achieve greater flexibility.

A secondary objective of the present invention is to have a portable power supply with detachable battery so that aging or malfunction battery can be easily replaced, thereby achieving greater environmental friendliness.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a portable power supply according to an embodiment of the present invention.

FIG. 2 is a perspective diagram showing the portable power supply of FIG. 1 when a rechargeable battery of the portable power supply is detached.

FIG. 3 is a schematic diagram showing a rechargeable battery of the portable power supply is charged by an external DC power source.

FIG. 4 is a schematic diagram showing a rechargeable battery of the portable supply charges or powers an external electronic device requiring DC power and another external electronic device requiring AC power.

FIG. 5 is a schematic diagram showing a rechargeable battery of the portable power supply is charged by an external DC power source, and an external electronic device requiring AC power is charged or powered by the portable power supply simultaneously.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

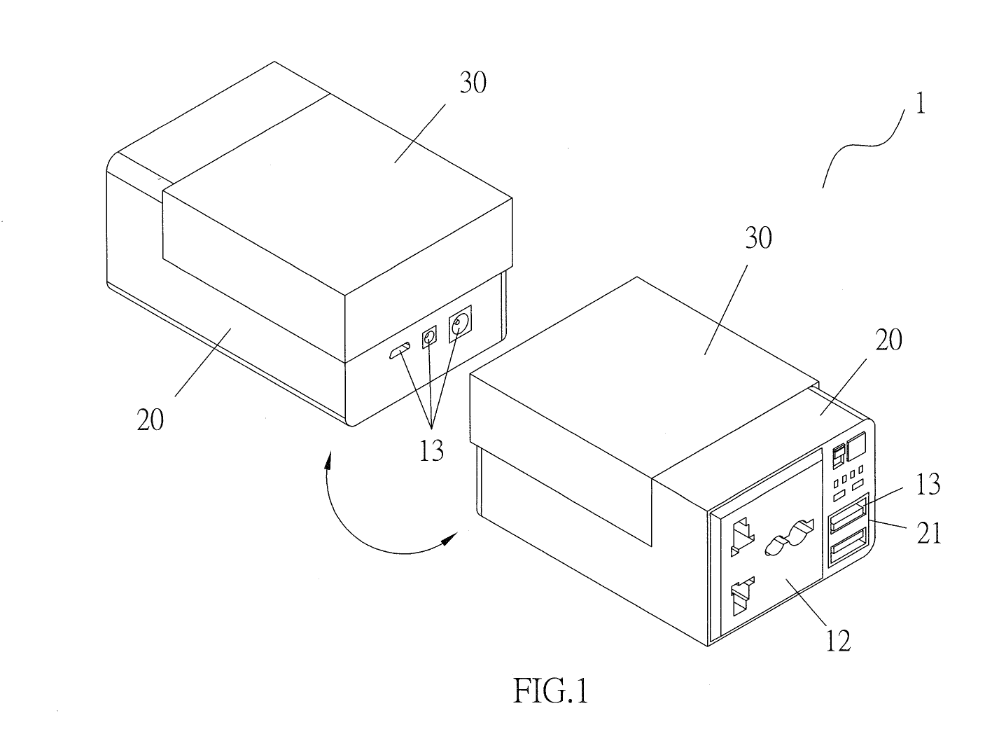

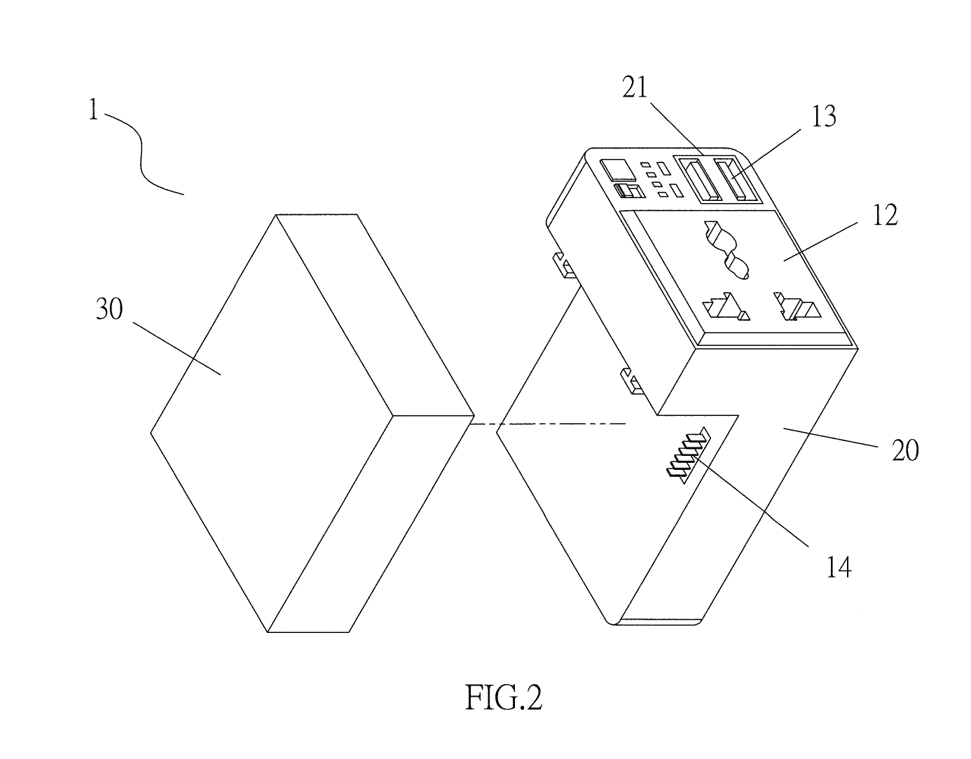

As illustrated in FIGS. 1 and 2, a portable power supply 1 according to an embodiment of the present invention contains at least a circuit unit 10, a casing 20, and at least a rechargeable battery 30. In the present embodiment, there is one circuit unit 10, and one rechargeable battery 30.

The circuit unit 10 contains a conversion circuit 11, at least an AC output port 12, at least a DC input/output port 13, and at least a coupling port 14. In the present embodiment, there is one AC output port 12, one DC input/output port 13, and one coupling port 14.

The casing 20 has a number of openings 21. The number of the openings 21 corresponds to the total number of AC output ports 12, the DC input/output ports 13, and the coupling ports 14. The casing 20 further has an accommodation space (not shown) inside, and the accommodation space is accessible through the openings 21. The circuit unit 10 is installed in the accommodation space 21 of the casing 20. Each of the AC output port 12, the DC input/output port 13, and the coupling port 14 is configured in and exposed from one of the openings 21.

The rechargeable battery 30 is coupled to the coupling port 14.

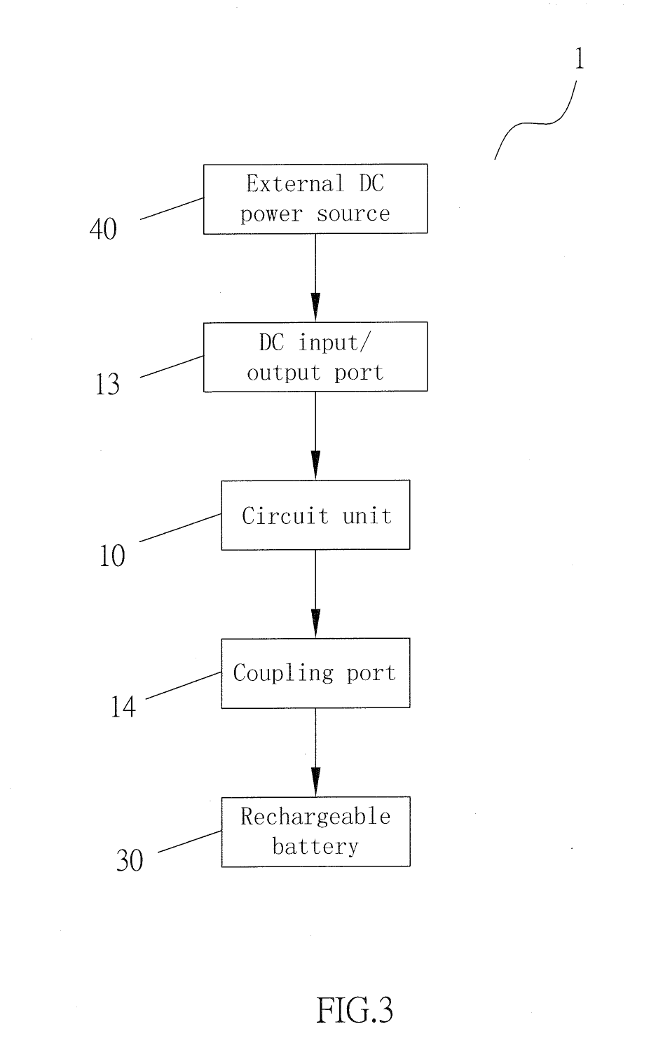

As shown in FIG. 3, the rechargeable battery 30 is recharged when the portable power supply 1 is connected to an external DC power source 40 through the DC input/output port 13. The external DC power source 40 charges the rechargeable battery 30 through the circuit unit 10 and the coupling port 14.

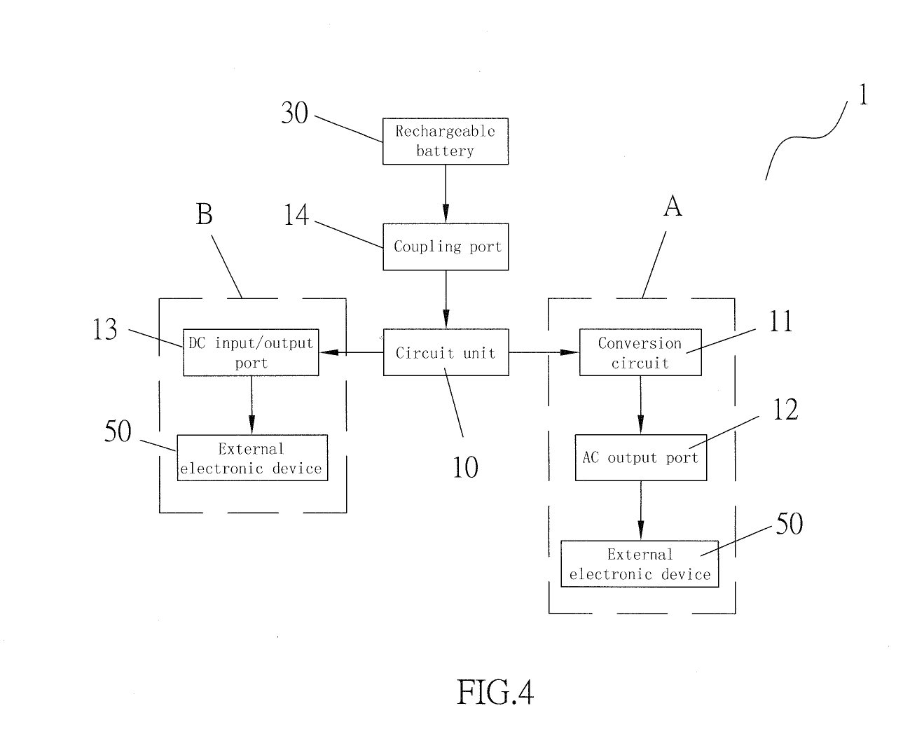

As shown in FIG. 4, when the portable power supply 1 is put to work, the DC electricity stored in the rechargeable battery 30 is delivered to the circuit unit 10 through the coupling port 14, and then to a first branch A and a second branch B. Following the first branch A, the DC electricity is transformed a pre-determined AC voltage by the conversion circuit 11, and the AC voltage is delivered to an external electronic device 50 through the AC output port 12. On the other hand, following the second branch B, the DC electricity is directly delivered to another external electronic device 50 through the DC input/output port 13. As such, the portable power supply 1 is capable of powering or charging one external electronic device 50 requiring AC power and another external electronic device 50 requiring DC power simultaneously.

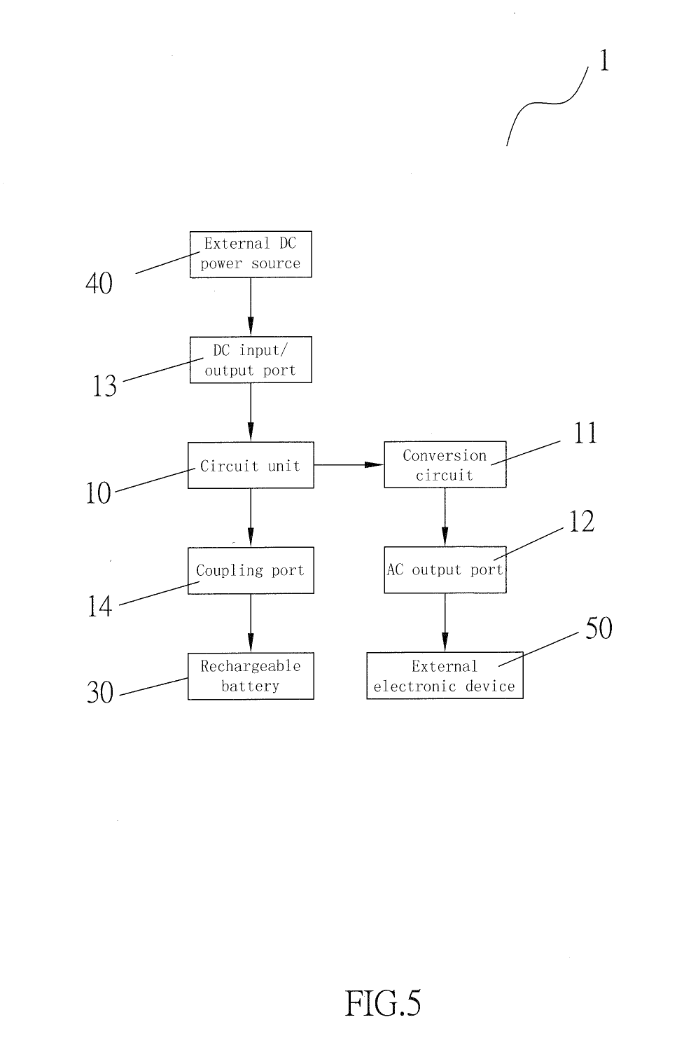

FIG. 5 depicts a scenario of the portable power supply 1 where it is charged by a connected external DC power source 40 and discharged to power a connected external electronic device 50 simultaneously. As illustrated, DC electricity is drawn from the external DC power source 40 through the DC input/output port 13 to the circuit unit 10. By the circuit unit 10, the DC electricity is used to charge the rechargeable battery 30 through the coupling port 14. In the meantime, the circuit unit 10 uses the conversion circuit 11 to transform the DC electricity to a pre-determined AC voltage, and the AC voltage is used to charge or power the external electronic device 50 through the AC output port 12.

The AC output port 12 is common AC power socket conforming to at least an international standard. The DC input/output port 13 is one conforming to at least one international standard or is a standard USB socket.

Additionally, the conversion circuit 11 and the AC output port 12 are detachably configured. As such, another AC output port 12 conforming to a different standard can be installed and used. Alternatively, the conversion circuit 11 and the AC output port 12 can be removed and an external electronic device 50 can be directly installed, thereby achieving greater usage flexibility

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A portable power supply, comprising:
at least a circuit unit, each comprising a conversion circuit, at least an AC output port, at least a DC input/output port, and at least a coupling port; and
at least a rechargeable battery, each coupled to one of the coupling ports;
wherein the DC electricity stored in a rechargeable battery is delivered to a circuit unit through a coupling port, and then to a first branch and a second branch; following the first branch, the DC electricity is transformed a pre-determined AC voltage by a conversion circuit of the circuit unit, and the AC voltage is delivered to a first external electronic device through an AC output port of the circuit unit; following the second branch, the DC electricity is directly delivered to a second external electronic device through a DC input/output port of the circuit unit; and, without connecting the second external electronic device, the DC input/output port is capable of connecting to an external DC power source for charging the rechargeable battery.

2. The portable power supply according to claim 1, wherein the conversion circuit and the AC output port are detachably configured.

3. The portable power supply according to claim 1, further comprising a casing; wherein the casing comprising a plurality of openings and an accommodation space inside accessible through the openings for the installation of the circuit unit; and each of the AC output ports, the DC input/output ports, and the coupling ports is configured in and exposed from one of the openings.

4. The portable power supply according to claim 1, wherein each AC output port is an AC power socket conforming to at least an international standard; and each DC input/output port is a DC power socket conforming to at least one international standard or is a standard USB socket.
